(19) United States
(12) Patent Application Publication
(10) Pub. No.: US 2016/0320663 A1
(43) Pub. Date: Nov. 3, 2016

(54) COLOR FILTER SUBSTRATE, MANUFACTURING METHOD THEREOF, METHOD FOR MANUFACTURING SPACERS, AND DISPLAY DEVICE

(71) Applicants: BOE TECHNOLOGY GROUP CO., LTD., Beijing (CN); ORDOS YUANSHENG OPTOELECTRONICS CO., LTD., Ordos (CN)

(72) Inventors: Mingqian HAO, Beijing (CN); Wei WANG, Beijing (CN); Ke ZHAO, Beijing (CN)

(21) Appl. No.: 15/086,874

(22) Filed: Mar. 31, 2016

(30) Foreign Application Priority Data
Apr. 30, 2015 (CN) 201510219230.1

(51) Int. Cl. G02F 1/1335; G02F 1/1339; B05D 3/00; G02B 5/20

(52) U.S. Cl. CPC G02F 1/133516; G02B 5/201; G02F 1/133512; G02F 1/13394; B05D 3/007; G02F 2001/133519

(57) ABSTRACT

A color filter substrate, a manufacturing method thereof, a method for manufacturing spacers, and a display device are disclosed. The color filter substrate includes: a black matrix and a color filter layer. Areas provided with the black matrix include first areas and second areas; the color filter layer is provided with grooves; the grooves of the color filter layer correspond to the first areas; the color filter layer and the black matrix are overlapped with each other at the second areas; and an upper surface of the color filter substrate at the second areas is higher than the upper surface of the color filter substrate at the first areas.

### TECHNICAL FIELD

Embodiments of the present disclosure relate to a color filter substrate, a manufacturing method thereof, a method for manufacturing spacers, and a display device.

### BACKGROUND

A liquid crystal display (LCD) generally comprises an array substrate and a color filter substrate arranged opposite to each other, and liquid crystals are provided between the two substrates. In order to ensure the spacing between the array substrate and the color filter substrate (namely the cell gap of the LCD), spacers are usually disposed on the color filter substrate.

### SUMMARY

A first aspect of the present disclosure provides a color filter substrate, which comprises: a black matrix and a color filter layer. Areas provided with the black matrix include first areas and second areas; the color filter layer is provided with grooves; the grooves of the color filter layer correspond to the first areas; the color filter layer and the black matrix are overlapped with each other at the second areas; and an upper surface of the color filter substrate at the second areas is higher than the upper surface of the color filter substrate at the first areas.

A second aspect of the present disclosure discloses a display device, which comprises: any color filter substrate of an embodiment of the disclosure, first spacers disposed on an upper surface of the color filter substrate at first areas, and second spacers disposed on the upper surface of the color filter substrate at second areas. The first spacer and the second spacer have a same thickness.

A third aspect of the present disclosure discloses a method for manufacturing a color filter substrate, which comprises: forming a black matrix on a base substrate, in which areas provided with the black matrix include first areas and second areas; and forming a color filter layer provided with grooves on the base substrate provided with the black matrix, in which the first areas correspond to the grooves; and the black matrix is covered by the color filter layer at the second areas, so that an upper surface of the color filter substrate at the second areas is higher than the upper surface of the color filter substrate at the first areas.

A fourth aspect of the present disclosure discloses a method for manufacturing spacers, which comprises: forming a spacer coating layer on any color filter substrate in the first aspect or first to fourth possible embodiments provided by the first aspect; and after performing exposure and development on the spacer coating layer via a fourth mask, forming first spacers on an upper surface of the color filter substrate at the first areas, and forming second spacers on the upper surface of the color filter substrate at the second areas, in which the fourth mask comprises transparent areas and opaque areas, and in exposure the transparent areas and the opaque areas correspond to the first spacers and the second spacers that are to be formed or the second spacers and the first spacers that are to be formed.

### BRIEF DESCRIPTION OF THE DRAWINGS

For more clear understanding of the technical proposals in the embodiments of the present disclosure, simple description will be given below to the accompanying drawings required to be used in the description of the embodiments or the prior art. Obviously, the accompanying drawings described below are only some embodiments of the present disclosure. Other accompanying drawings may also be obtained by those skilled in art without creative work on the basis of the accompanying drawings.

FIG. 1 is a schematic sectional view of a color filter substrate;

FIG. 2 is a schematic diagram illustrating a manufacturing process of spacers;

FIG. 3 is a schematic structural top view of a color filter substrate provided by a first embodiment;

FIG. 4 is a sectional view of the color filter substrate along line AA provided by the first embodiment, as illustrated in FIG. 3;

FIG. 5a is another schematic sectional view of the color filter substrate provided by the first embodiment;

FIG. 5b is another schematic structural top view of the color filter substrate provided by the first embodiment;

FIG. 6 is a schematic diagram of a display device provided by a second embodiment;

FIG. 7a is a flowchart of a method for manufacturing a color filter substrate provided by a third embodiment;

FIG. 7b is a schematic diagram of black matrix formed in the method for manufacturing the color filter substrate provided by the third embodiment of the present disclosure;

FIG. 8 is a schematic diagram of a mask in the third embodiment of the present disclosure;

FIG. 9 is a schematic diagram of another mask in the third embodiment of the present disclosure;

FIG. 10 is a schematic diagram of another mask in the third embodiment of the present disclosure;

FIG. 11 is a schematic diagram of another mask in the third embodiment of the present disclosure;

FIG. 12 is a schematic diagram of another mask in the third embodiment of the present disclosure;

FIG. 13 is a schematic diagram of another mask in the third embodiment of the present disclosure;

FIG. 14 is a flowchart of a method for manufacturing spacers, provided by a fourth embodiment of the present disclosure; and

FIG. 15 is a schematic diagram illustrating the process of forming spacers in the fourth embodiment of the present disclosure.

### DETAILED DESCRIPTION

As for a screen of an LCD, in order to buffer the pressure acting on the screen of the LCD, spacers with step (height difference) therebetween are formed on the color filter substrate for example to ensure the strength of the screen.

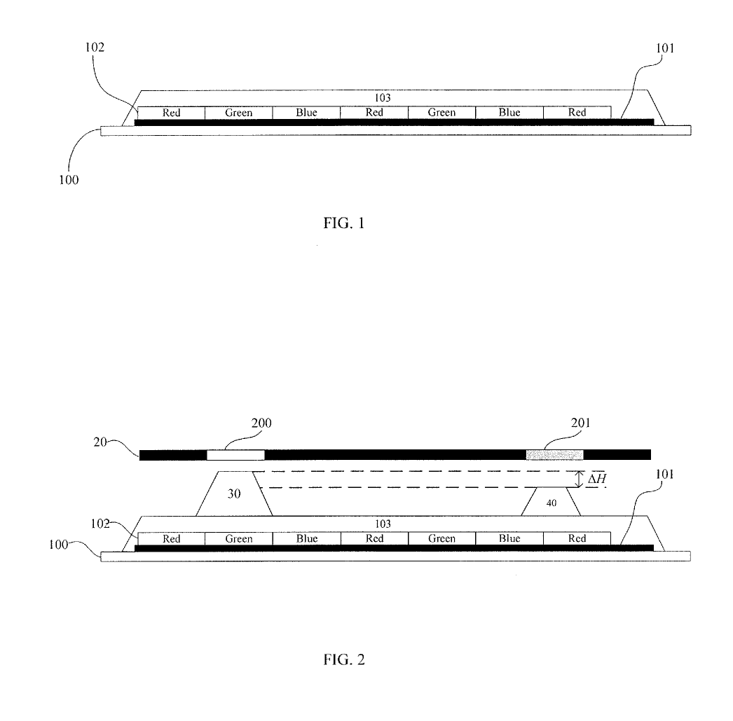

A color filter substrate 10, as illustrated in FIG. 1, comprises: a base substrate 100 and a black matrix 101, a color filter layer 102 and an overcoat layer 103 disposed on the base substrate in sequence. Spacers with step(s) therebetween may be formed on the overcoat layer at positions corresponding to the black matrix via a half-tone mask. In the schematic diagram illustrating the manufacturing process of spacers, as illustrated in FIG. 2, spacers with step(s) therebetween are formed by exposure and development upon a photoresist layer formed on the overcoat layer via a half-tone mask. Specifically, a transparent area 200 of a half-tone mask 20 is used for forming spacers (primary spacers) with a larger thickness, and a semitransparent area 201 of the half-tone mask 20 is used for forming spacers (auxiliary spacers) with a smaller thickness. Thus, a step (height difference) can be formed between the primary spacers and the auxiliary spacers. Ultraviolet light for exposing almost completely runs through the area 200 of the half-tone mask but partially run through the area 201. As the area 200 and the area 201 have different transmittances for the light for exposing, the exposure degrees of photoresist in different corresponding areas become different, and hence spacers formed corresponding to the area 200 and the area 201 have different heights. Therefore, a step ΔH is formed between spacers 30 and spacers 40 on the manufactured color filter substrate. However, as a half-tone mask is very expensive and the semitransparent area is difficult to manufacture, the manufacturing cost is increased.

The color filter substrate, the manufacturing method thereof, the method for manufacturing the spacers, and the display device that are provided by the embodiments of the present disclosure can reduce manufacturing costs as a common mask can be to form spacers with step(s) therebetween.

Description will be given below to the technical proposals in the embodiments of the present disclosure with reference to the accompanying drawings for the embodiments of the present disclosure. Obviously, the described embodiments are only a portion of the embodiments of the present disclosure and not all the embodiments. All other embodiments obtained by those skilled in the art without creative work on the basis of the described embodiments of the present disclosure shall fall within the scope for protection of the present disclosure.

### Embodiment 1

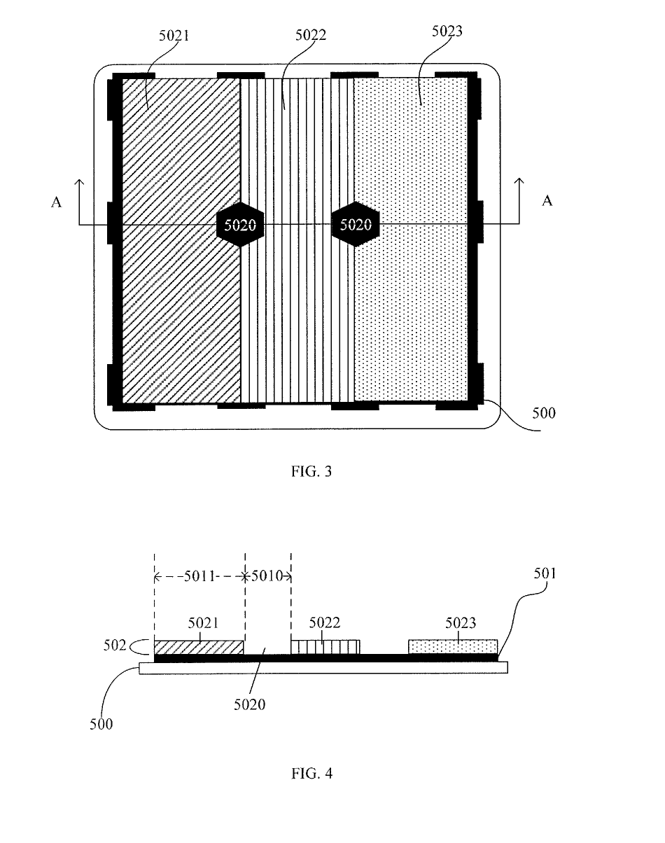

The embodiment of the present disclosure provides a color filter substrate 50. FIG. 3 is a schematic structural top view of the color filter substrate 50, and FIG. 4 is a sectional view of the color filter substrate 50 along line AA as illustrated in FIG. 3.

As illustrated in FIG. 3, the color filter substrate 50 comprises: a base substrate 500, a black matrix 501 and a color filter layer 502, in which the color filter layer 502 is provided with grooves 5020 or openings 5020.

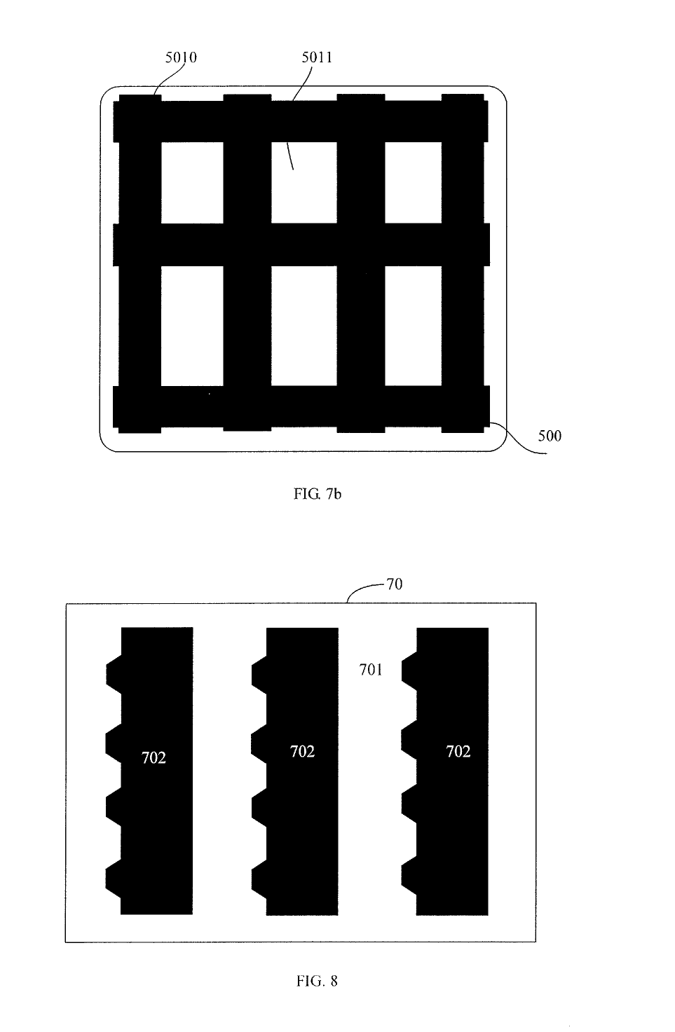

Also, as illustrated in FIG. 4, it also can be understood that the color filter substrate 50 comprises the base substrate 500, the black matrix 501 and the color filter layer 502. Areas provided with the black matrix 501 include first areas 5010 and second areas 5011 (as illustrated in FIG. 7b); the color filter layer is provided with grooves 5020; the grooves 5020 of the color filter layer correspond to the first areas 5010; the color filter layer and the black matrix are overlapped with each other at the second areas 5011; and an upper surface of the color filter substrate at the second area 5011 is higher than the upper surface of the color filter substrate at the first area 5010.

It should be noted that: in the embodiments, areas corresponding to the grooves of the color filter layer are referred to as first areas, and areas provided with the black matrix, other than the first areas, are referred to as second areas.

In the drawings, the color filter layer is formed on the black matrix and configured to cover the black matrix. Of course, the black matrix may also be formed on the color filter layer. No limitation will be given to the sequence.

The color filter layer generally includes three types of primary color patterns. As illustrated in FIG. 3 or 4, the color filter layer 50 includes first primary color patterns 5021, second primary color patterns 5022 and third primary color patterns 5023 arranged in sequence, e.g., red (R) patterns, green (G) patterns and blue (B) patterns. Or in another example, the color filter layer may further include fourth primary color patterns, e.g., white (W) patterns (also referred to as colorless, e.g., transparent pattern). Nevertheless, detailed description will be given in the following embodiments by taking the case that the color filter layer includes three types of primary color patterns as an example.

The distribution/configuration of the primary color patterns may be various. Illustratively, a primary color pattern may correspond to a sub-pixel unit (a sup-pixel unit of a display device); or a primary color pattern may correspond to a plurality of sub-pixel units, for instance, correspond to one column of sub-pixel units of the display device.

For instance, the grooves are openings. An area not provided with the color filter layer produces a groove. As illustrated in FIG. 3, the grooves are closed, namely is an aperture. For example, if no gaps are formed among the first primary color pattern, the second primary color pattern and the third primary color pattern sequentially arranged in a color filter unit of the color filter layer, a groove or grooves can be formed in a closed configuration, namely an opening or openings can be obtained.

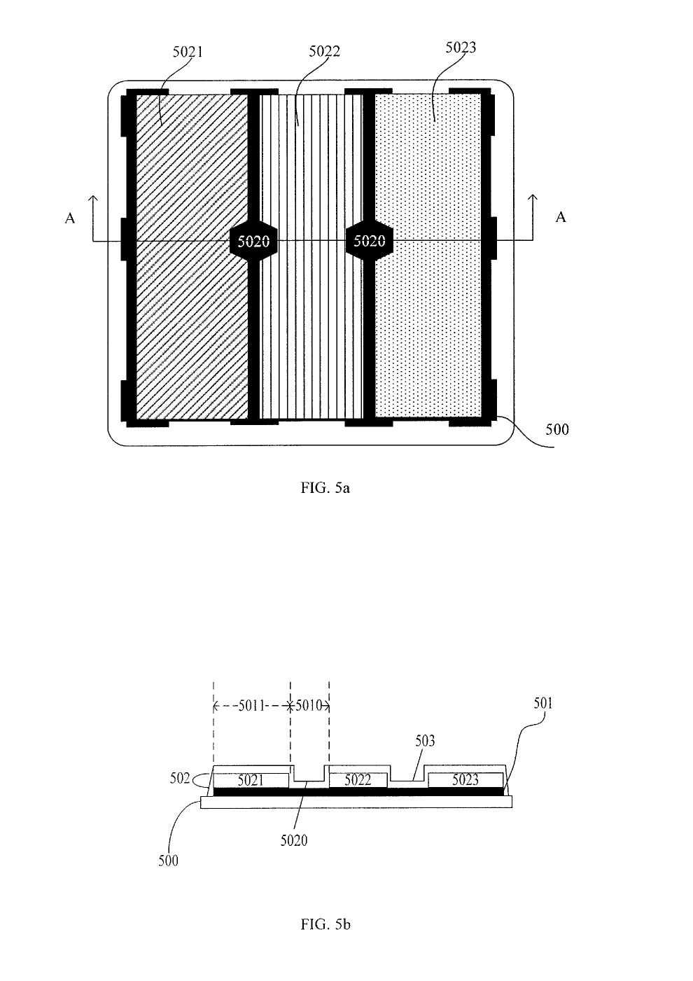

Of course, as illustrated in FIG. 5a, a groove 5020 may be opened, i.e., not closed. For example, if gaps are formed among the first primary color pattern, the second primary color pattern and the third primary color pattern sequentially arranged in the color filter unit of the color filter layer, the grooves may be formed in an open configuration. For example, a gap is formed between the first primary color pattern and the second primary color pattern, and a gap is formed between the second primary color pattern and the third primary color pattern.

The upper surface of the color filter substrate is the surface provided with the spacers, for instance, it may be an upper surface of the color filter layer or an upper surface of the overcoat layer. If the color filter substrate further comprises an alignment film and the spacers are disposed on the alignment film, the surface of the alignment film may be deemed as the upper surface of the color filter substrate.

Because the upper surface of the color filter layer at the first area corresponding to the groove is lower than the upper surface of the color filter layer at the second area overlapped with the black matrix, although the spacers formed via a common mask have a single thickness, a spacer may be formed on the upper surface of the first area and a spacer may be formed on the upper surface of the second area, so that a step can be produced between the two spacers. Thus, the case that one pair of spacers with a step therebetween are formed via an expensive half-tone mask can be avoided, and hence the cost can be saved.

Moreover, when one primary color pattern corresponds to a plurality of sub-pixel units, a mask for forming the color filter layer is relatively simple. In this case, the color filter layer further includes circularly arranged color filter units. Each color filter unit includes: a first primary color pattern, a second primary color pattern and a third primary color pattern arranged in sequence.

A first notch is formed on one side of the first primary color pattern close to the second primary color pattern; a second notch is formed on one side of the second primary color pattern close to the first primary color pattern; and the first notch and the second notch are combined to form the opening.

Illustratively, if a notch 1 is formed on one side of the first primary color pattern close to the second primary color pattern and a notch 2 is formed on one side of the second primary color pattern close to the first primary color pattern in FIG. 3, the notch 1 and the notch 2 are combined to form an opening between an R pixel pattern and a G pixel pattern.

A third notch is formed on one side of the second primary color pattern close to the third primary color pattern; a fourth notch is formed on one side of the third primary color pattern close to the second primary color pattern; and the third notch and the fourth notch are combined to form the opening.

Illustratively, a notch 3 is formed on one side of the second primary color pattern close to the third primary color pattern and a notch 4 is formed on one side of the third primary color pattern close to the second primary color pattern in FIG. 4, the notch 3 and the notch 4 are combined to form an opening between the G pixel pattern and a B pixel pattern.

Moreover, the first areas are disposed at joint positions of the black matrix. That is to say, low upper surfaces of the color filter layer are all disposed at the joint positions of the black matrix. The spacers arranged as such will not affect the transmittance of the entire display device.

In an embodiment of the present disclosure, as illustrated in FIG. 5b, the color filter substrate may further comprise an overcoat layer 503 covering both the black matrix and the color filter layer. It should be noted that: because the color filter layer is provided with the grooves, a surface of the overcoat layer covering the color filter layer is also provided with grooves (or concave portions); the grooves correspond to the first areas; and an upper surface of the overcoat layer disposed at the second area is higher than the upper surface of the overcoat layer disposed at the first area with respect to the base substrate 500. For instance, the overcoat layer 503 conformally covers the black matrix and the color filter layer.

The color filter substrate provided by an embodiment of the present disclosure comprises a color filter layer and a black matrix, and the color filter layer is provided with grooves. The grooves of the color filter layer correspond to first areas of the black matrix; the color filter layer and the black matrix are overlapped with each other at second areas of the black matrix; and an upper surface of the color filter substrate at the second areas is higher than the upper surface of the color filter substrate at the first areas with respect to a base substrate. As the upper surface of the color filter substrate is provided with the grooves, a step may be formed between any two spacers if these two spacers arranged on the color filter substrate have a same thickness but at different areas having different surface heights of the color filter substrate. Thus, a plurality of spacers with step(s) therebetween can be formed via a common mask, so that an expensive half-tone mask is not required, and hence the cost can be saved.

### Embodiment 2

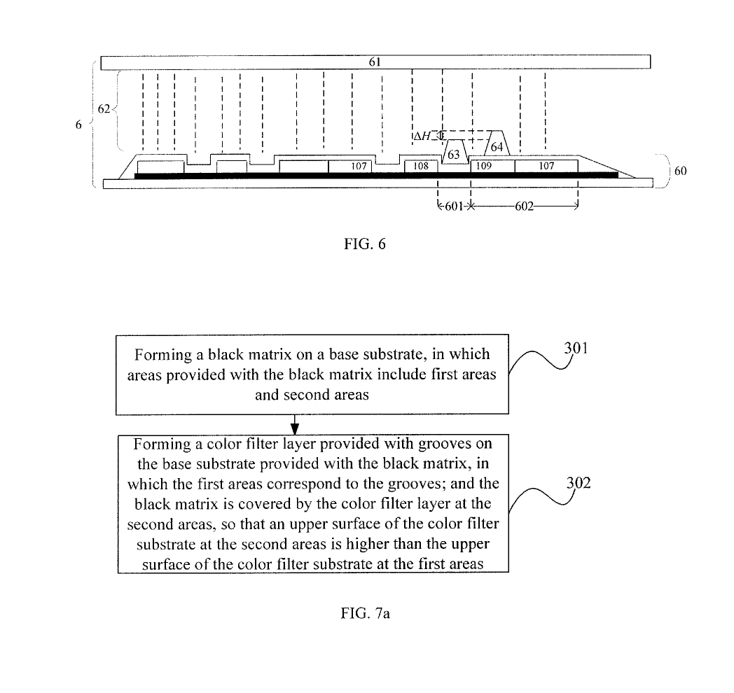

The embodiment of the present disclosure further provides a display device 6. As illustrated in FIG. 6, the display device 6 comprises: a color filter substrate 60 (namely the color filter substrate 50 provided by the first embodiment of the present disclosure), an array substrate 61, liquid crystals 62 between the color filter substrate 60 and the array substrate 61, and spacers disposed on an upper surface of the color filter substrate. The spacers are between the two substrates.

As the black matrix of the color filter substrate 60 includes two areas having different upper surface heights, the color filter substrate 60 includes first areas 601 and second areas 602, and the upper surface of a first area 601 is lower than the upper surface of a second area 602. As illustrated in FIG. 6, a first spacer 63 disposed on the upper surface of the color filter substrate 60 at the first area 601 and a second spacer 64 disposed on the upper surface of the color filter substrate at the second area 602 have a same thickness, and a step ΔH is formed between the first spacer 63 and the second spacer 64.

The display device provided by the embodiment of the present disclosure comprises the color filter substrate, the second spacers disposed on the upper surface of the color filter substrate at the second areas, and the first spacers disposed on the upper surface of the color filter substrate at the first areas. Because the upper surface of the first areas of the color filter substrate is lower than the upper surface of the second areas, although the two spacers have a same thickness, due to the different surface heights of the areas where they are located, the two spacers have a step therebetween. Thus, the spacers with step(s) therebetween can be formed via a common mask, so that an expensive half-tone mask is not required any more, and hence the cost can be saved.

For example, the array substrate of the embodiment of the present disclosure includes a plurality of gate lines and a plurality of data lines which intersect each other to define a pixel units arranged in a matrix, each pixel unit comprising a thin film transistor as a switch element, and a pixel electrode.

### Embodiment 3

The embodiment of the present disclosure further provides a method for manufacturing a color filter substrate. As illustrated in FIG. 7, the method comprises the following steps 301 to 302.

S301: forming a black matrix on a base substrate, in which areas provided with the black matrix include first areas and second areas.

For instance, the black matrix may be formed on the base substrate via coating, exposure and development processes and are provided on an upper surface of the base substrate. The black matrix includes horizontally distributed first sub-areas and vertically distributed second sub-areas; for example, the first sub-areas are parallel to upper and lower edges of the upper surface of the base substrate, and the second sub-areas are perpendicular to the upper and lower edges of the upper surface of the base substrate. An intersection point of any fist sub-area and any second sub-area is a joint position of the black matrix. The areas provided with the formed the black matrix 500 include first areas 5010 and second areas 5011; grooves 5020 of the subsequently formed color filter layer correspond to the first areas 5010; and the color filter layer is overlapped with the black matrix 500 at the second areas 5011.

S302: forming a color filter layer provided with grooves on the base substrate provided with the black matrix, in which the first areas correspond to the grooves; and the black matrix is covered by the color filter layer at the second areas, so that an upper surface of the color filter substrate at the second areas is higher than the upper surface of the color filter substrate at the first areas.

For instance, the grooves are openings. For instance, if no gap is formed among a first primary color pattern, a second primary color pattern and a third primary color pattern sequentially arranged in a color filter unit of the color filter layer, the groove or grooves may be closed, namely an opening or openings.

In one example, the process of forming the color filter layer provided with the grooves on the base substrate provided with the black matrix includes the following steps:

1. Forming first primary color patterns on the base substrate provided with the black matrix via a first mask 70, in which the first mask includes transparent areas and opaque areas, and the shape of the transparent areas or the opaque areas is the same as that of the first primary color patterns.

If the material for the first primary color patterns is coated on the base substrate provided with the black matrix, the material may have characteristics of positive photoresist. Thus, the transparent areas of the fist mask have the same shape as the first primary color patterns. If negative photoresist is coated on the base substrate provided with the black matrix, the opaque areas of the first mask have the same shape as the first primary color patterns.

Illustratively, the first mask 70 may be as illustrated in FIG. 8. The first mask 70 includes: transparent areas 701 and opaque areas 702. One side of each opaque area of the first mask is toothed, so that a notch or notches can be formed on one side of each formed first primary color pattern close to a second primary color pattern. Positive photoresist is coated on the base substrate provided with the black matrix. After the exposure and development processes via the first mask as illustrated in FIG. 8, the first primary color patterns having the same shape as the opaque areas of the first mask will be formed on the base substrate provided with the black matrix.

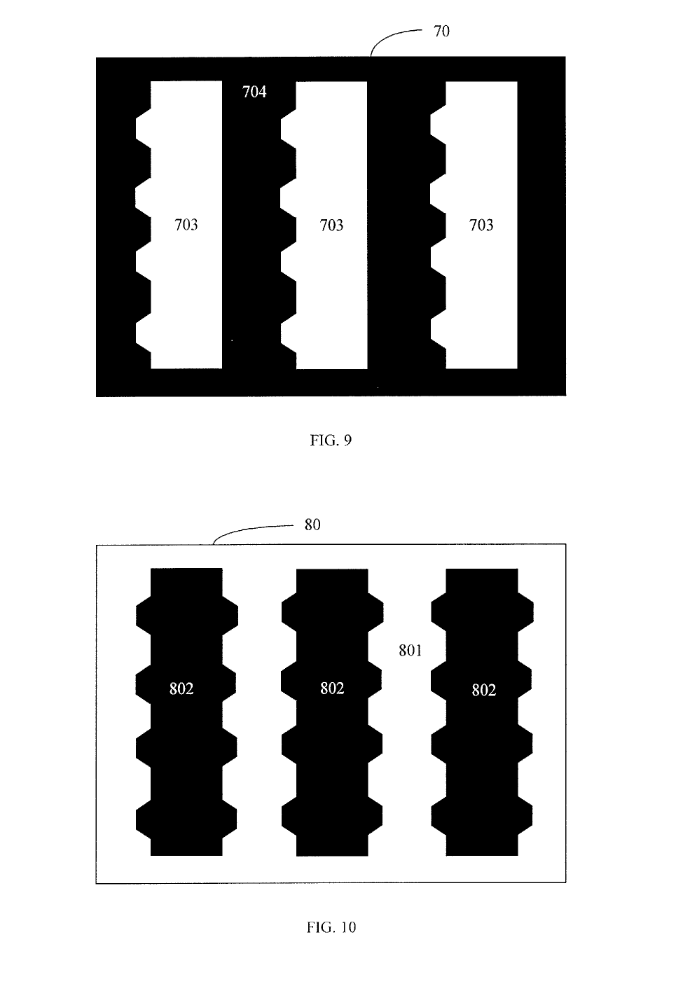

Moreover, illustratively, the first mask 70 may also be as illustrated in FIG. 9. The first mask 70 includes: transparent areas 703 and opaque areas 704. One side of each transparent area of the first mask is toothed, so that a notch or notches are formed on one side of each formed first primary color pattern close to a second primary color pattern. Negative photoresist is coated on the base substrate provided with the black matrix. After the exposure and development processes via the first mask as illustrated in FIG. 9, the first primary color patterns having the same shape as the transparent areas of the first mask will be formed on the base substrate provided with the black matrix.

2. Forming second primary color patterns on the base substrate provided with the black matrix via a second mask 80, in which the second mask includes transparent areas and opaque areas, and the shape of the transparent areas or the opaque areas is the same as that of the second primary color patterns.

Similarly, if positive photoresist is coated on the base substrate provided with the black matrix, the opaque areas of the second mask have the same shape as the second primary color patterns. If negative photoresist is coated on the base substrate provided with the black matrix, the transparent areas of the second area have the same shape as the second primary color patterns.

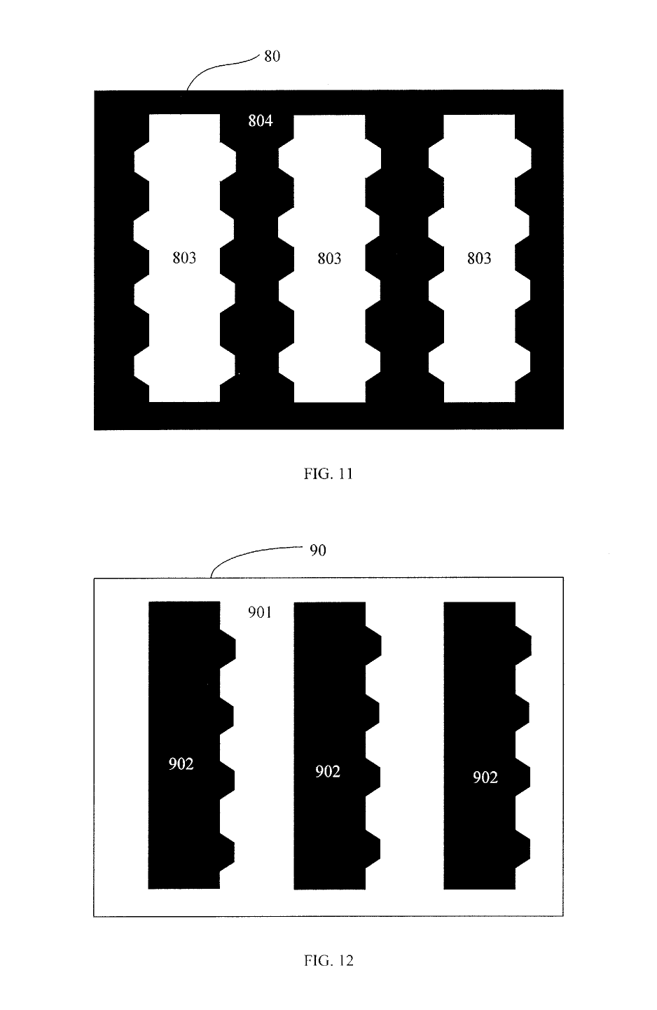

Illustratively, if the second mask 80 is the mask as illustrated in FIG. 10, the second mask 80 includes transparent areas 801 and opaque areas 802. If positive photoresist is used for coating, the shape of the second primary color patterns formed after exposure and development is the same as that of the opaque areas of the mask as illustrated in FIG. 10. If the second mask 80 is the mask as illustrated in FIG. 11, the second mask 80 includes transparent areas 803 and opaque areas 804. If negative photoresist is used for coating, the shape of the second primary color patterns formed after exposure and development is the same as that of the transparent areas of the mask as illustrated in FIG. 11.

3. Forming third primary color patterns on the base substrate provided with the black matrix via a third mask 90, in which the third mask includes transparent areas and opaque areas, and the shape of the transparent areas or the opaque areas is the same as that of the third primary color patterns.

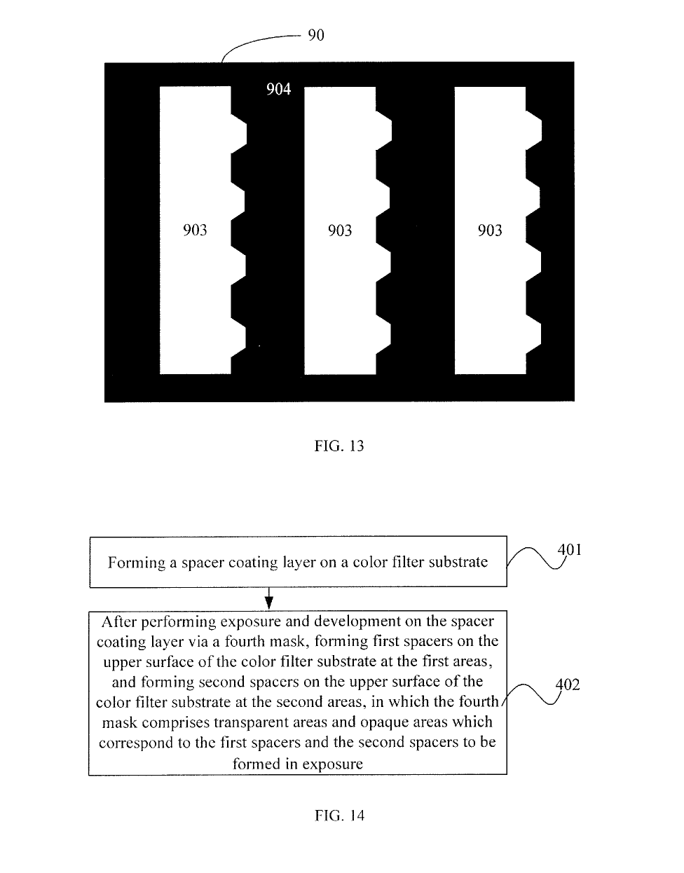

Similarly, if positive photoresist is coated on the base substrate provided with the black matrix, the opaque areas of the third mask has same shape as the third primary color patterns. If negative photoresist is coated on the base substrate provided with the black matrix, the transparent areas of the third mask have the same shape as the third primary color patterns. Illustratively, if the third mask 90 is the mask as illustrated in FIG. 12, the third mask includes transparent areas 901 and opaque areas 902. If positive photoresist is used for coating, the shape of the third primary color patterns formed after exposure and development is the same as that of the opaque area of the mask as illustrated in FIG. 12. If the third mask 90 is the mask as illustrated in FIG. 13, the third mask includes transparent areas 903 and opaque areas 904. If negative photoresist is used for coating, the shape of the third primary color patterns formed after exposure and development is the same as that of the transparent areas of the mask as illustrated in FIG. 13.

It should be noted that: a first notch or notches are formed on one side of a first primary color pattern close to a second primary color pattern; a second notch or notches are formed on one side of the second primary color pattern close to the first primary color pattern; the first notch(s) and the second notch(s) are combined to form the opening(s); a third notch or notches are formed on one side of a second primary color pattern close to a third primary color pattern; a fourth notch or notches are formed on one side of the third primary color pattern close to the second primary color pattern; and the third notch(s) and the fourth notch(s) are combined to form the opening(s). Illustratively, if the first primary color pattern, the second primary color pattern and the third primary color pattern in FIG. 3 are respectively R, G and B patterns. With reference to FIG. 3, a notch 1 is formed on one side of an R pixel pattern close to a G pixel pattern; a notch 2 is formed on one side of the G pixel pattern close to the R pixel pattern; and the notch 1 and the notch 2 are combined to form an opening between the R pixel pattern and the G pixel pattern. A notch 3 is formed on one side of the G pixel pattern close to a B pixel pattern; a notch 4 is formed on one side of the B pixel pattern close to the G pixel pattern; and the notch 3 and the notch 4 are combined to form an opening between the G pixel pattern and the B pixel pattern.

In the method for manufacturing the color filter substrate, provided by an embodiment of the present disclosure, the black matrix and the color filter layer are formed on the base substrate, and the color filter layer is provided with grooves. The areas provided with the black matrix include the first areas and the second areas; the grooves of the color filter layer correspond to the first areas; and the color filter layer is overlapped with the black matrix at the second areas. The upper surface of the color filter substrate at the second areas is higher than the upper surface of the color filter substrate at the first areas. Thus, a spacer is formed on the upper surface of the color filter substrate at a second area, and a spacer is formed on the upper surface of the color filter substrate at a first area, by means of exposing via a common mask. Although the two spacers have a same thickness, due to different surface heights of the areas where they are located, the two spacers have a step therebetween. Thus, the spacers with step(s) therebetween can be formed via a common mask, so that an expensive half-tone mask is not required, and hence the cost can be saved.

### Embodiment 4

The embodiment of the present disclosure provides a method for manufacturing spacers. As illustrated in FIG. 14, the method comprises the following steps 401 to 402.

S401: forming a spacer coating layer on a color filter substrate.

The color filter substrate may be any color filter substrate provided by the first embodiment and comprises: a black matrix and a color filter layer. Areas provided with the black matrix include first areas and second areas, and the color filter layer is provided with grooves. The grooves of the color filter layer correspond to the first areas; and the color filter layer is overlapped with the black matrix at the second areas, so that an upper surface of the color filter substrate at the second areas is higher than the upper surface of the color filter substrate at the first areas.

S402: after performing exposure and development on the spacer coating layer via a fourth mask, forming first spacers on the upper surface of the color filter substrate at the first areas, and forming second spacers on the upper surface of the color filter substrate at the second areas, in which the fourth mask comprises transparent areas and opaque areas, and in exposure the transparent areas and opaque areas correspond to the first spacers and the second spacers to be formed or the second spacers and the first spacers.

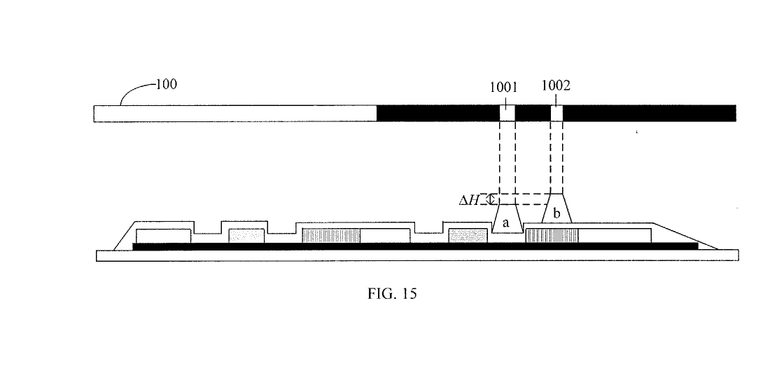

For instance, the fourth mask may be a common mask. Illustratively, FIG. 15 is a schematic diagram illustrating the process of forming spacers via a fourth mask 100 in the present disclosure. As illustrated in the figure, ultraviolet light almost completely runs through an area 1001 and an area 1002 of the fourth mask 100. Because the transmittance of the area 1001 and the area 1002 is almost one hundred percent, the spacers formed at the area 1001 and the area 1002 have a same thickness. Moreover, a spacer a is formed on the upper surface of the first area of the color filter substrate and a spacer b is formed on the upper surface of the second area of the color filter substrate; and the upper surface of the second area is higher than the upper surface of the first area, and therefore a step ΔH is formed between the spacer a and the spacer b on the manufactured color filter substrate.

In the method for manufacturing the spacers provided by any embodiment of the present disclosure, a spacer is formed on the upper surface of the color filter substrate at the second area, and a spacer is formed on the upper surface of the color filter substrate at the first area, by means of via a common mask. Although the two spacers have a same thickness, as the upper surface of the second area of the color filter substrate is higher than the upper surface of the first area of the color filter substrate with respect to the base substrate, a step is formed between the two spacers. Thus, the spacers with step(s) therebetween can be formed via a common mask, so that an expensive half-tone mask is not required, and hence the cost can be saved.

The foregoing is only the preferred embodiments of the present disclosure and not intended to limit the scope of protection of the present disclosure. The scope of protection of the present disclosure should be defined by the appended claims.

What is claimed is:

1. A color filter substrate, comprising: a black matrix and a color filter layer, wherein areas provided with the black matrix include first areas and second areas; the color filter layer is provided with grooves;
the grooves of the color filter layer correspond to the first areas; the color filter layer and the black matrix are overlapped with each other at the second areas; and an upper surface of the color filter substrate at the second areas is higher than the upper surface of the color filter substrate at the first areas.

2. The color filter substrate according to claim 1, wherein the grooves are openings.

3. The color filter substrate according to claim 2, wherein the color filter layer further includes circularly arranged color filter units; each color filter unit includes: a first primary color pattern, a second primary color pattern and a third primary color pattern that are arranged in sequence;
a first notch is formed on one side of the first primary color pattern close to the second primary color pattern; a second notch is formed on one side of the second primary color pattern close to the first primary color pattern: the first notch and the second notch are combined to form the opening; and
a third notch is formed on one side of the second primary color pattern close to the third primary color pattern; a fourth notch is formed on one side of the third primary color pattern close to the second primary color pattern; and the third notch and the fourth notch are combined to form the opening.

4. The color filter substrate according to claim 1, wherein the first areas are disposed at joint positions of the black matrix.

5. The color filter substrate according to claim I further comprising: an overcoat layer covering the black matrix and the color filter layer.

6. A display device, comprising: the color filter substrate according to claim 1, first spacers disposed on an upper surface of the color filter substrate at first areas, and second spacers disposed on the upper surface of the color filter substrate at second areas; and the first spacers and the second spacers have a same thickness.

7. A method for manufacturing a color filter substrate, comprising:
forming a black matrix on a base substrate, in which areas provided with the black matrix include first areas and second areas;
forming a color filter layer provided with grooves on the base substrate provided with the black matrix, in which the first areas correspond to the grooves; and the black matrix is covered by the color filter layer at the second areas, so that an upper surface of the color filter substrate at the second areas is higher than the upper surface of the color filter substrate at the first areas.

8. The method according to claim 7, wherein the grooves are openings.

9. The method according to claim 8, wherein first primary color patterns are formed on the base substrate provided with the black matrix via a first mask; the first mask includes transparent areas and opaque areas; a shape of the transparent areas or the opaque areas is the same as that of the first primary color patterns;
second primary color patterns are formed on the base substrate provided with the black matrix via a second mask; the second mask includes transparent areas and opaque area; a shape of the transparent areas or the opaque areas is the same as that of the second primary color patterns;
third primary color patterns are formed on the base substrate provided with the black matrix via a third mask; the third mask includes transparent areas and opaque areas; and a shape of the transparent areas or the opaque areas is the same as that of the third primary color patterns.

10. The method according to claim 9, wherein a first notch is formed on one side of a first primary color pattern close to a second primary color pattern; a second notch is formed on one side of the second primary color pattern close to the first primary color pattern; the first notch and the second notch are combined to form the opening;
a third notch is formed on one side of the second primary color pattern close to a third primary color pattern; a fourth notch is formed on one side of the third primary color pattern close to the second primary color pattern; and the third notch and the fourth notch are combined to form the opening.

11. A method for manufacturing spacers, comprising:
forming a spacer coating layer on a color filter substrate, wherein the color filter substrate, comprises a black matrix and a color filter layer, areas provided with the black matrix include first areas and second areas; the color filter layer is provided with grooves, the grooves of the color filter layer correspond to the first areas, the color filter layer and the black matrix are overlapped with each other at the second areas, and an upper surface of the color filter substrate at the second areas is higher than the upper surface of the color filter substrate at the first areas; and
after performing exposure and development on the spacer coating layer via a fourth mask, forming first spacers on an upper surface of the color filter substrate at the first areas, and forming second spacers on the upper surface of the color filter substrate at the second areas, in which the fourth mask comprises transparent areas and opaque areas, and in exposure the transparent areas and the opaque areas correspond to the first spacers and the second spacers that are to be formed or the second spacers and the first spacers that are to be formed.
